(19) United States
(12) Patent Application Publication
(10) Pub. No.: US 2003/0140760 A1
(43) Pub. Date: Jul. 31, 2003

(54) Film cutter

(76) Inventor: Steven Bory, Lake Forest, IL (US)

Correspondence Address: SEYFARTH SHAW, 55 EAST MONROE STREET, SUITE 4200, CHICAGO, IL, 60603-5803, US

(21) Appl. No.: 10/054,916

(22) Filed: Jan. 25, 2002

(51) Int. Cl. B26D 5/08; B26D 7/00

(52) U.S. Cl. 83/614; 83/649; 83/175

(57) ABSTRACT

A device is provided for cutting lengths of film from a roll of film such as thin plastic film. A roll retainer for the roll of film is provided, typically a box structure having a hinged lid. An inner platform is provided on which a first portion of film from the roll rests, plus a first film retainer for retaining the first film portion on the inner platform. A movable cutter member is for cutting off the length of the film from the roll. An outer platform is provided with a second film retainer for retaining a cut film portion on the outer platform, with the cutter member being positioned between the inner and outer platforms.

### BACKGROUND OF THE INVENTION

Large quantities of plastic film are manufactured and used in which the plastic film typically is provided on a roll. When needed, lengths of the plastic film are unrolled and cut off from the main supply of the roll, often using a serrated metal edge which is carried on a box that contains the plastic roll. For example, Saran™ plastic film is sold in this manner in supermarkets and elsewhere for domestic wrapping uses.

It is a well-known problem that plastic film such as Saran clings together and is difficult to keep in a spread-out condition for best wrapping. Instead, the limp plastic film folds over on itself and adheres to enough of an extent that the separation can be somewhat difficult and inconvenient.

In an attempt to address this known problem of plastic films, various plastic film cutters and dispensers have been disclosed, for example, those that are found in Chuang U.S. Pat. No. 4,960,022 and Capitao, Jr. et. al. U.S. Pat. No. 5,758,559. In both of these cases, a plastic film cutter is provided, in conjunction with a container for the roll of plastic, in which a sliding blade moves transversely along a track back and forth to cut off lengths of plastic as they are extended from the roller. However, in both cases the cut plastic tends to immediately fall away, and thus needs to be grasped, generally only with one hand, since the other hand of the user is operating the transversely sliding cutter blade. Because of that, the cut plastic film, being generally very limp, can fold back upon itself with sections adhering to each other, resulting in the common problem that is encountered with plastic film: that it is difficult to keep the plastic film unfolded and free of adhesion to itself.

Similarly, on the other side of the cutter blade, the length of plastic film that remains attached to the roll can fall back onto the roll, creating the common problem of a difficulty of pulling the free end of the plastic film loose from the roll, as is often encountered by homemakers and others who make use of plastic film in rolls.

By this invention, a device for cutting lengths of film from a roll of film is provided in which, preferably, the cut film is retained by the device after cutting so that it may be grabbed with both hands and not be as likely to crumple up and self-adhere. Also, preferably, the free end of the roll of plastic may be retained in spaced relation from the roll, to prevent the end from falling back onto the roll, thus avoiding the repeated difficulty of separating the film end from the rest of the roll of film, as is conventionally such a common occurrence.

### DESCRIPTION OF THE INVENTION

By this invention, a device is provided for cutting lengths of film from a roll of film, which device comprises the following: A roll retainer is provided for the roll of film, typically a box or other type of retainer for the film roll. An inner platform is provided, typically carried by the roll retainer, on which a first portion of film from the roll resides. A first film retainer is provided for retaining the first film portion on the inner platform, typically by gentle pressure retention. A movable cutter member is provided for cutting off a length of the film from the roll. An outer platform is provided, plus a second film retainer for retaining a cut film portion on the outer platform.

The cutter member is positioned between the inner and outer platforms, so that the inner platform and its retainer can retain the free end of the film extending from the roll, and the outer platform and the second film retainer can retain the cut film portion, until the user is ready to take it.

Typically, the film is thin plastic film such as Saran, or polyethylene film, of the type used for wrapping. Also, the film cutter of this invention may be used for other types of plastic film, or metal foils, laminated films, paper, paper-plastic laminates, and the like, all of which may be included in the word “film”.

Typically, the roll retainer comprises a container for the roll of plastic, in which the container has a hinged lid. It is preferred for the hinged lid to integrally carry the first and second film retainers, which can press down respectively onto the inner and outer platforms, carried by the container. Also, the hinged lid may carry the movable cutter member.

It may be desired for the inner platform to define a first transverse groove. The first film retainer comprises the first retention member carried by the hinged lid that presses a first film portion into the groove when the lid is closed. Similarly, a second groove may be defined in the outer platform, and the second film retainer comprises a second retention member carried by the hinged lid that presses the cut film portion into the second groove when the lid is closed. Thus, both pieces of plastic film can be retained until the user is ready to grasp the cut piece of film with both hands, and pull it loose from retention, which is easily done since the hinged lid will simply rise a bit to release the cut film when being pulled loose by the user. At the same time, the first film portion, attached to the roll of film, may not inconveniently fall back onto the roll, since it is retained on the inner platform.

Also, the lid holds the plastic film before and during cutting, to stabilize it.

Thus, a device for cutting lengths of film, and preferably soft, highly flexible, plastic film, is provided where lengths of the film are easily transversely severed, but are still retained until the user is ready to grasp them for use, reducing the problem of the fold up of the cut plastic film, with portions of the film adhering to each other. At the same time, the free end of the roll of plastic is similarly retained in a manner that it is unlikely to fall back onto the plastic roll, so that the next section of plastic film may be conveniently advanced for cutting without the necessity of finding the end of the plastic as it adheres to the roll.

### DESCRIPTION OF THE DRAWINGS

In the drawings, FIG. 1 is a perspective view of the device of this invention;

FIG. 2 is a sectional view taken along line 2-2 of FIG. 1 of the device;

FIG. 3 is a top plan view of the device of FIG. 1;

FIG. 4 is a front elevational view of the device of FIG. 1; and

FIG. 5 is a fragmentary, enlarged sectional view of a portion of a modified device which is otherwise similar to the device of FIG. 1;

FIG. 6 is a sectional view of another embodiment of the device of this invention, similar to FIG. 2 in its view showing the cutter member in its cutting position;

FIG. 7 is an enlarged view of a portion of FIG. 6, showing the cutter member of this embodiment in a retracted position from its cutting position;

FIG. 8 is an elevational view of the cutter member of FIG. 7, rotated 90° about a vertical axis from the view of FIG. 7.

### DESCRIPTION OF SPECIFIC EMBODIMENTS

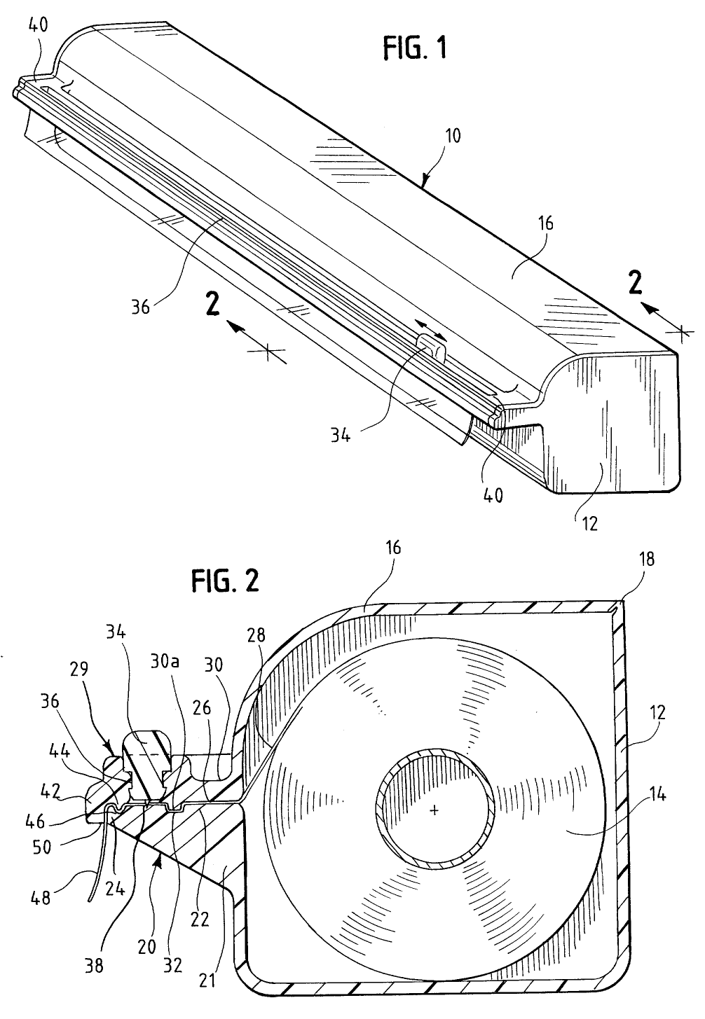

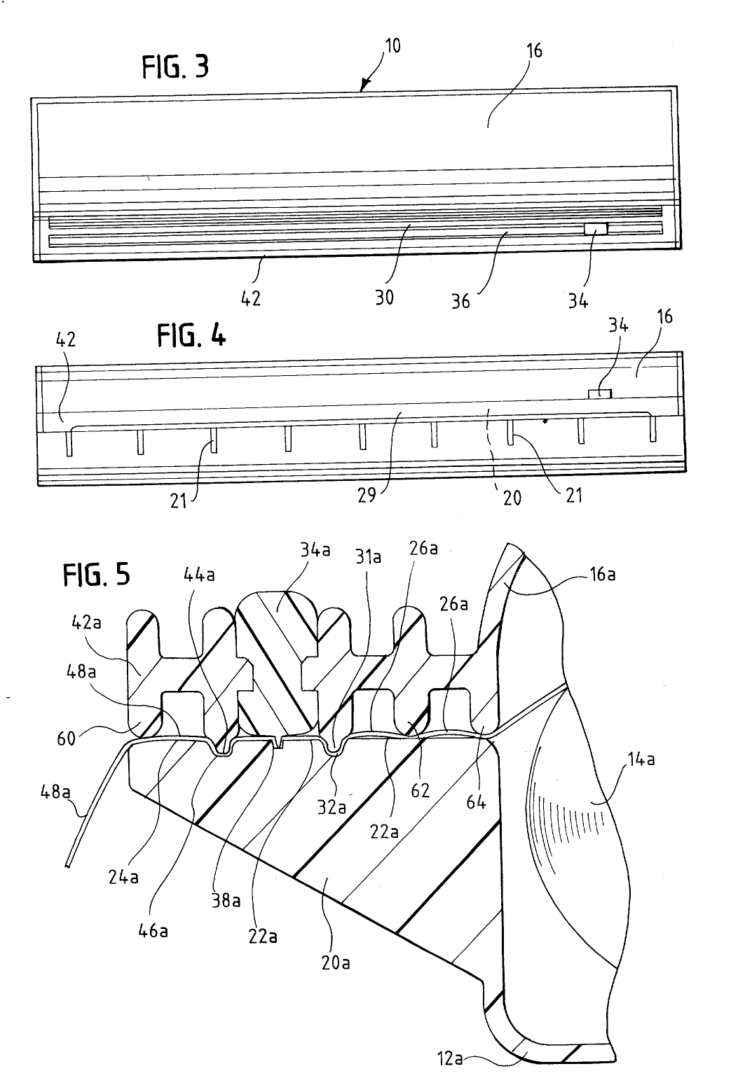

Referring to FIGS. 1-4, film cutting device 10 comprises a container 12 for containing a roll of plastic film 14, with container 12 defining a lid 16, which connects to the remainder of container 12 by a plastic hinge 18. Thus, it can be seen that both the container 12 and the lid 16, and other components as well, can be made integral as a single, molded piece of structural plastic.

Container 12, which serves as a retainer for roll of plastic film 14, also defines a platform 20, which further comprises an inner platform 22 and an outer platform 24. As shown, a first portion 26 of the roll's strip of film 28 rests on inner platform 22. Platform 20 is supported by reinforcing ribs 21.

Lid 16 defines projecting structure 29 defining a first film retainer 30 which, in this particular embodiment, includes a projection 30a which fits into first, transverse groove 32 of inner platform 22. Thus, when lid 16 is closed, the film strip portion 26 is retained, and unlikely to slip back to lie against the remainder of the roll of film 14, but instead remains in a position to be grasped and advanced so that a further strip of film may be cut.

Cutter member 34 is shown to define a sliding handle in a track and slot arrangement 36 defined in the projecting structure that defines first film retainer 30. Cutter 34 defines a blade 38, and operates by transverse motion back and forth, as shown particularly in FIG. 1, within the slot 36, which is shown to have closed ends 40. Cutter member 34 operates in a manner that is generally similar, apart from details of structure, to the cutter members of the prior art.

Outer platform 24 also engages with second film retainer 42, which comprises a projection 44 that fits into horizontal recess 46, so that the outer film portion 48, which is or becomes the cut film portion after operation of cutter 34, is still retained by the gentle frictional pressure retention on the film between the engaging outer platform 24 and second film retainer 42. This particularly includes in this embodiment projection 44 and recess 46 into which projection 42 projects, to retain the cut film portion 48 until the user is ready to grasp it, so that the cut film portion can be manually or otherwise retained in a flat, unfolded configuration without self-adhering portions.

After removal of cut portion 48, lid 16 may be opened, and film portion 26, 28 advanced for desired distance to cut another length of film when desired.

Also, it can be noted that cut film portion 48 is preferably directed downwardly by end slot 50 between sections 24, 42, so that it may be manually grasped rather in the manner of a paper towel, and that self-adhesion through folding is thus reduced.

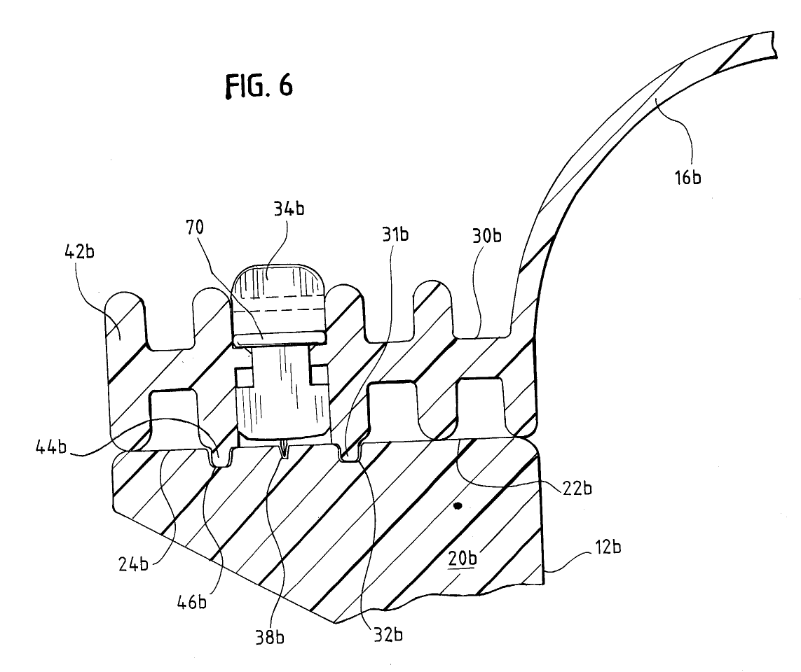

Referring to FIG. 5, a container 12a functions as a retainer for roll of plastic film 14a, having a hinged lid 16a and other structure in the manner similar to the previous embodiment of FIGS. 1-4 except as otherwise disclosed herein.

In this embodiment, a platform 20a is carried by container 12a, comprising inner platform 22a, which is inside of cutter blade 38a, which is carried by sliding cutter 34a in a manner similar to the previous embodiment. Outer platform 24a is also provided outside of cutter blade 38a. Inner and outer platforms 22a, 24a, can respectively support lengths 28a, 48a of plastic film, with the outer lengths of plastic film 48a being cut by cutter 34a, while being retained by the interaction between second groove 46a on platform 24a and lateral projection 44a, carried on the second film retainer 42a.

Similarly, as in the previous embodiment, inner platform 22a defines a transverse groove 32a, with a transverse projection 30a comprising part of the first retention member and projecting into groove 32a to retain the first film portion 26a in its position spaced from roll 14a as lid 16a is closed.

After removal of the outer film strip 48a, lid 16a can be opened, and first film portion 26a can be advanced, which advances film off of roll 14a, to measure out a desired length of film to be cut. Then, lid 16a is closed once again, and cutter 34a sweeps across the entire width of the film strip to separate a new, cut portion of film 48a. This cut film portion is retained by the retainer member 44a acting with groove 46a, and also by the supplemental retainer member 60 pressing against platform 24a.

Similarly, the new first film portion 26a, connected to roll 14a, is retained and positioned by the interacting members 31a, 32a, plus the interaction of supplemental members 62, 64 pressing against portions of inner platform 22a while the lid is closed, to keep film section 26a from falling back into contact with roll 14a.

Thus a device for cutting lengths of film is provided, having greater convenience of use for rapid cutting of desired lengths, without the disadvantages encountered previously with respect particularly to rolls of thin plastic film.

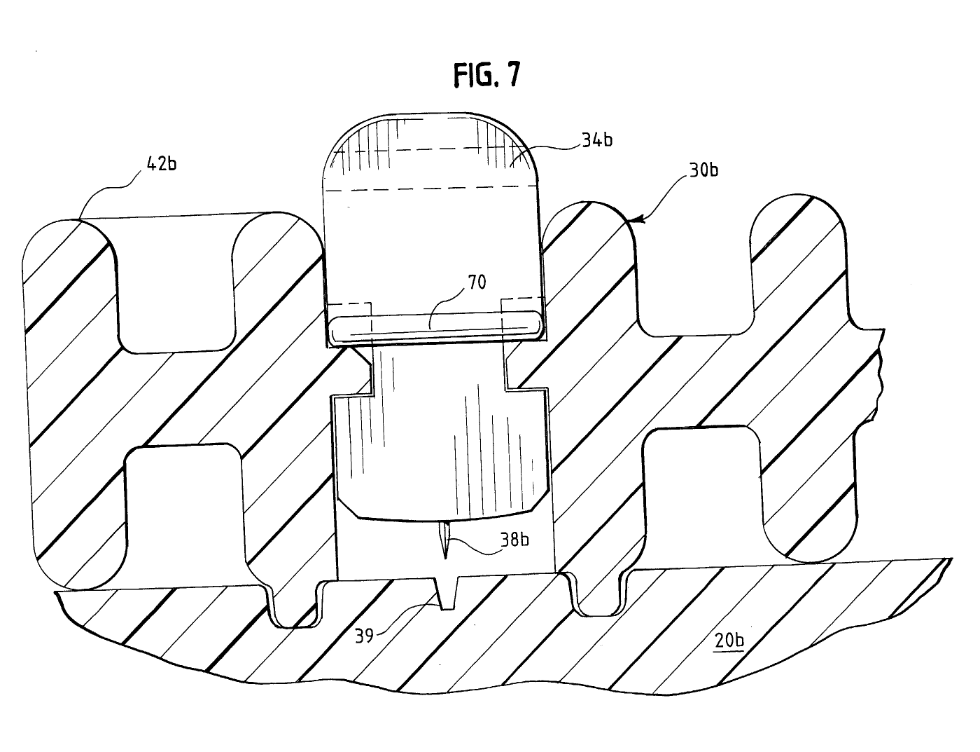

Referring to FIGS. 6-8, another embodiment of the invention is disclosed, being similar to the previous embodiments except as otherwise shown and disclosed herein.

As in the previous embodiments, a container 12b functions as a retainer for a roll of plastic film (not shown). Container 12b has a hinged lid 16b in a manner similar to the previous embodiments.

As before, platform 20b is carried by container 12b, comprising inner platform 22b, which is inside cutter blade 38b, which is carried by sliding cutter 34b in a manner similar to the previous embodiments except as otherwise described herein. Outer platform 24b is also provided outside of cutter blade 38b.

As before, inner and outer platforms 22b and 24b can respectively support and hold lengths of plastic film, with the outer lengths of plastic film being cut off by cutter 34b, while being retained by the interaction between second groove 46b on platform 24b and lateral projection 44b, carried on the second film retainer 42b. Similarly, as in the previous embodiment, inner platform 22b defines a transverse groove 32b. Transverse projection 31b of the inner platform 30b comprises a part of the first retention member, and projects into groove 32b to retain a first film portion in a position spaced from the plastic roll as the lid is closed.

As in the previous embodiments, after removal of an outer film strip, lid 16b can be opened and a first film portion can be advanced, to advance film off of the roll, to measure out a desired length of film to be cut. Then the lid is closed once again, and cutter 34b sweeps across the entire width of the film strip to separate a new-cut portion of film, while the film is retained so that it does not bunch up during cutting.

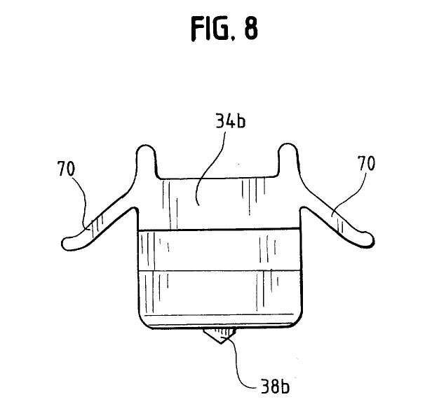

As a new feature of this embodiment, FIG. 7 shows cutter 34b in a normal, elevated position in which the cutter blade 38b is spaced from the groove 39 in which it normally operates. Cutter 34b, with its blade 38b, is biased in this position of FIG. 7 by a pair of spring members comprising integral spring arms 70 (FIG. 8) which are carried on the body of the cutter and are biased to hold cutter 34b in the upward position of FIG. 7. However, cutter 34b may be manually pressed downwardly into the position shown in FIG. 6, when lid 16b is closed, to penetrate the plastic film, and to be manually pushed laterally across the width of the plastic film to cut it while being pressed downwardly. Then, upon release of cutter member 34b, it springs upwardly again to the position of FIG. 7.

Thus, this embodiment has all of the advantages of the previous embodiments, and additionally, cutting blade 38b is normally retained in a recessed, shielded mode to reduce the possibility of accidental injury to someone handling the device.

Cutter member 34b and especially spring members 70 may be desirably made of acetal resin such as Daledin™ manufactured by the Dupont Chemical Company or Selcon™ by Celanese. Preferably, the entire cutter member 34b and attached spring members 70 may be integrally molded as a single piece.

The above has been offered for illustrative purposes only, and is not intended to limit the scope of the invention of this application, which is as defined in the claims below.

That which is claimed is:

1. A device for cutting lengths of film from a roll of film, which comprises:
a roll retainer for the roll of film;
an inner platform on which a first portion of film from said roll rests;
a first film retainer for retaining a first film portion on said inner platform;
a movable cutter member for cutting off a length of said film from said roll;
an outer platform;
and a second film retainer for retaining a cut film portion on said outer platform, said cutter member being positioned between the inner and outer platforms.

2. The device of claim 1 in which said roll retainer integrally carries said inner and outer platforms.

3. The device of claim 1 in which said roll retainer comprises a container having a hinged lid.

4. The device of claim 4 in which said hinged lid integrally carries the first and second film retainers.

5. The device of claim 4 in which said hinged lid carries the movable cutter member.

6. The device of claim 3 having a first groove in the inner platform and in which the first film retainer comprises a first retention member carried by the hinged lid that presses said first film portion into said first groove when the lid is closed.

7. The device of claim 6 having a second groove in the outer platform in which the second film retainer comprises a second retention member carried by the hinged lid that presses said cut film portion into said second groove when the lid is closed.

8. The device of claim 3 having a second groove in the outer platform in which the second film retainer comprises a second retention member carried by the hinged lid that presses said cut film portion into said second groove when the lid is closed.

9. The device of claim 7 in which said roll retainer integrally carries said inner and outer platforms.

10. The device of claim 9 in which said hinged lid integrally carries the first and second film retainers.

11. The device of claim 10 in which said hinged lid carries the movable cutter member.

12. The device of claim 11 in which said moveable cutter member is spring-biased to assume a retracted position in which the cutter member is spaced from the film, and said cutter member can be pressed into an advanced position in which said film may be cut by transverse motion of said cutter member.

13. A device for cutting lengths of film from a roll of plastic film, which comprises:
a roll retainer carrying a roll of plastic film;
an inner platform on which a first portion of film from said roll rests;
a first film retainer, for retaining said first film portion on said inner platform;
a movable cutter member for cutting off a length of said film from said roll;
an outer platform; and
a second film retainer for retaining a plastic film portion of said outer platform, said cutter member being positioned between the inner and outer platforms.

14. The device of claim 13 in which said roll retainer integrally carries said inner and outer platforms.

15. The device of claim 14 in which said roll retainer comprises a container having a hinged lid.

16. The device of claim 15 in which said hinged lid integrally carries the first and second film retainers.

17. The device of claim 15 of which said hinged lid carries the movable cutter member.

18. The device of claim 17 having a first groove in the inner platform and in which the first film retainer comprises a first retention member carried by the hinged lid that presses said first film portion into said first groove when the lid is closed.

19. The device of claim 18 having a second groove in the outer platform and in which the second film retainer comprises a second retention member carried by the hinged lid that presses said cut film portion into said second groove when the lid is closed.

20. The device of claim 13 having a first groove in the inner platform and in which the first film retainer comprises a first retention member carried by a hinged lid that presses said first film portion into said first groove when the lid is closed.

21. The device of claim 13 in which a second groove in the outer platform is provided and in which the second film retainer comprises a second retention member carried by a hinged lid of said roll retainer that presses said cut film portion into said second groove when the lid is closed.

22. The device of claim 13 in which said moveable cutter member is spring biased into a retracted position in which a cutter blade carried by the cutter member does not engage said film, said moveable cutter member being manually pressable into an advanced position where said cutter blade can penetrate and cut said film whereby movement of said cutter member in the advanced position can cut off said length of film from the roll.
